(19) United States
(12) Patent Application Publication
(10) Pub. No.: US 2013/0050411 A1
(43) Pub. Date: Feb. 28, 2013

(54) VIDEO PROCESSING DEVICE AND VIDEO PROCESSING METHOD

(71) Applicant: Kunihiko Kawahara, Tokyo (JP)

(72) Inventor: Kunihiko Kawahara, Tokyo (JP)

(73) Assignee: KABUSHIKI KAISHA TOSHIBA, Tokyo (JP)

(21) Appl. No.: 13/402,610

(22) Filed: Feb. 22, 2012

(30) Foreign Application Priority Data
Aug. 31, 2011 (JP) 2011-189518

(51) Int. Cl. H04N 13/00

(52) U.S. Cl. 348/42; 348/E13.001

(57) ABSTRACT

A video processing device has a depth data generator which generates depth data corresponding to video data of each frame for performing frame rate conversion, depending on a logical value of a control signal, the logical value changing from a first logical value to a second logical value before the video data is outputted the first frame number of times when the first frame number is larger than the second frame number, and a three-dimensional data generator which generates three-dimensional video data based on the video data of each frame after the frame rate conversion by the frame rate converter, and on the depth data corresponding to the video data of each frame.

### CROSS REFERENCE TO RELATED APPLICATIONS

This application is based upon and claims the benefit of priority from the prior Japanese Patent Application No. 2011-189518, filed on Aug. 31, 2011, the entire contents of which are incorporated herein by reference.

### FIELD

Embodiments of the present invention relate to a video processing device for converting a frame rate.

### BACKGROUND

General video data such as movie content and animation has a frame rate of 24 fps (the number of frames/second), while Japanese TV broadcasting data has a frame rate of approximately 60 fps. Further, video data having a frame rate of 30 fps exists. Accordingly, in order to reproduce 30-fps or 24-fps video data by a TV receiver, frame rate conversion is necessary.

30-fps video data can be easily converted into 60-fps video data by doubly arranging each frame video. However, when performing so-called 2-3 pull-down processing for converting 24-fps video into 60-fps video data, the process of repeating one frame video repeatedly for two frames and the process of repeating one frame video repeatedly for three frames have to be alternately switched, which means the number of times each frame is repeated is not even.

Recently, a so-called 3D TV for displaying a three-dimensional video has been widely used. In order to create three-dimensional video data, a special video camera is required, which leads to a problem of high cost. Further, various restrictions are imposed on the transmission of three-dimensional video data through normal airwaves, since data volume remarkably increases compared to two-dimensional video data.

Therefore, there is a problem that stereoscopic video display cannot be fully enjoyed since three-dimensional video content is not widely available and 3D TV itself is expensive, and there is a likelihood that this problem becomes an obstruction to the spread of 3D TV. A technique for adding depth information to two-dimensional video data to generate pseudo three-dimensional video data viewable with 3D TV has been suggested.

Further, 3D TV displaying a stereoscopic video viewable with glasses-less eyes requires multi-parallax data. When the multi-parallax data is not included in input video data, depth information corresponding to two-dimensional video data or three-dimensional video data having two parallaxes, and multi-parallax data is generated based on this depth information.

When adding depth information to two-dimensional video data or three-dimensional video data having two parallaxes, the depth information has to be arranged for each frame video. When converting the frame rate by performing the above 2-3 pull-down processing, the process of repeating video data repeatedly for two frames and the process of repeating video data repeatedly for three frames have to be alternately performed.

In conventional techniques, the 2-3 pull-down processing and the process of generating depth information are asynchronously performed, which makes it impossible, in the process of generating depth information, to correctly judge whether the depth information of a certain frame video should be repeated for two frames or for three frames. Thus, there was a likelihood that depth information corresponding to the frame video generated through the 2-3 pull-down processing cannot be correctly generated.

### BRIEF DESCRIPTION OF THE DRAWINGS

FIG. 1 is a block diagram showing the schematic structure of a video processing device according to one embodiment of the present invention.

FIG. 2 is a flow chart showing an example of the processing operation performed by the video processing device of FIG. 1.

FIG. 3 is a flow chart showing an example of a detailed process step of Step S3 in FIG. 2.

FIG. 4 is a flow chart showing an example of a detailed process step of Step S4 in FIG. 2.

FIG. 5 is an operation timing diagram of the components of the video processing device of FIG. 1.

FIG. 6 is an operation timing diagram of the components of the video processing device of FIG. 1 when 1920×1080p at 23.976 Hz Frame Packing, which is one of three-dimensional video data formats, is inputted.

### DETAILED DESCRIPTION

According to the present embodiment, a video processing device has:

an image processor configured to perform image processing on two-dimensional or three-dimensional input video data;

a frame rate converter configured to perform frame rate conversion to output video data of one frame of successive two frames of the video data after the image processing by the image processor repeatedly for a first frame number of times and to output video data of another frame of the successive two frames of the video data repeatedly for a second frame number of times;

a depth data generator configured to generate depth data corresponding to the video data of each frame for performing the frame rate conversion by the frame rate converter, depending on a logical value of a control signal, the logical value changing from a first logical value to a second logical value before the video data is outputted the first frame number of times when the first frame number is larger than the second frame number; and

a three-dimensional data generator configured to generate three-dimensional video data based on the video data of each frame after the frame rate conversion by the frame rate converter, and on the depth data corresponding to the video data of each frame.

Embodiments will now be explained with reference to the accompanying drawings.

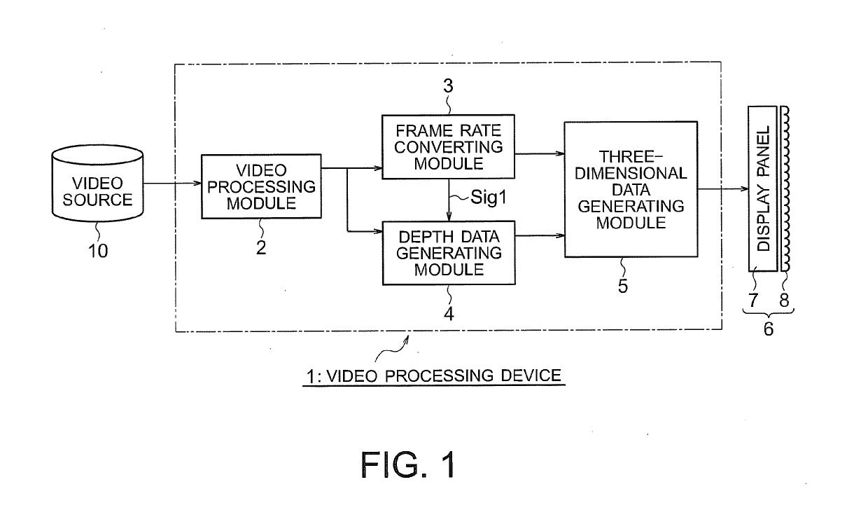

FIG. 1 is a block diagram showing the schematic structure of a video processing device according to one embodiment of the present invention. The video processing device of FIG. 1 has a video processing module 2, a frame rate converting module 3, a depth data generating module 4, and a three-dimensional data generating module 5.

The video processing module 2 performs various kinds of image processing on the two-dimensional video data or three-dimensional video data provided from a video source 10. The image processing includes a decoding process, a denoising process, etc., and concrete processes of the image processing are not questioned. The video source 10 may be so-called net content provided through a network such as the Internet, video content recorded in a DVD or a BD (Blu-ray Disc), or broadcast content provided through digital broadcasting waves. The video processing module 2 performs various kinds of image processing on the two-dimensional video data or three-dimensional video data included in such content.

The frame rate converting module 3 performs various kinds of frame rate conversion, and hereinafter, 2-3 pull-down processing for converting frame rate from 24 fps to 60 fps will be explained in detail as an example.

The depth data generating module 4 generates depth data corresponding to each frame having a frame rate converted by the frame rate converting module 3

The combination of the frame rate converting module 3 and the depth data generating module 4 corresponds to a three-dimensional information generation preparing unit.

The three-dimensional data generating module 5 generates three-dimensional video data, based on the frame video data of each frame having a frame rate converted by the frame rate converting module 3, and on the depth data corresponding to the frame video data.

The generated three-dimensional video data is transmitted to a flat display device 6 shown in FIG. 1, and three-dimensional (stereoscopic) video is displayed.

The flat display device 6 has a display panel 7 having pixels arranged in a matrix, and a light ray controlling element 8 having a plurality of exit pupils arranged to face the display panel 7 to control the light rays from each pixel of the display panel 7. The display panel 7 can be formed as a liquid crystal panel, a plasma display panel, or an EL (Electro Luminescent) panel, for example. The light ray controlling element 8 is generally called a parallax barrier, and each exit pupil of the light ray controlling element 8 controls light rays so that different images can be seen from different angles in the same position. Concretely, a slit plate having a plurality of slits or a lenticular sheet (cylindrical lens array) is used to create only right-left parallax (horizontal parallax), and a pinhole array or a lens array is used to further create up-down parallax (vertical parallax). That is, each exit pupil is a slit of the slit plate, a cylindrical lens of the cylindrical lens array, a pinhole of the pinhole array, or a lens of the lens array serves.

Although the flat display device 6 according to the present embodiment has the light ray controlling element 8 having a plurality of exit pupils, a transmissive liquid crystal display etc. may be used as the flat display device 6 to electronically generate the parallax barrier and electronically and variably control the form and position of the barrier pattern. That is, concrete structure and style of the flat display device 6 are not questioned as long as the display device can display a stereoscopic video based on the three-dimensional video data generated by the three-dimensional data generating module 5.

In the present embodiment, the frame rate converting module 3 and the depth data generating module 4 operate in synchronization with each other. More concretely, while the frame rate converting module 3 outputs a certain frame video repeatedly for two frames, the depth data generating module 4 outputs the depth data corresponding to this frame video repeatedly for two frames, and while the frame rate converting module 3 outputs a certain frame video repeatedly for three frames, the depth data generating module 4 outputs the depth data corresponding to this frame video repeatedly for three frames.

In order that the frame rate converting module 3 and the depth data generating module 4 operate in synchronization with each other, the frame rate converting module 3 transmits a frame rate conversion control signal Sig1 to the depth data generating module 4. This frame rate conversion control signal Sig1 changes to High level immediately before the frame rate converting module 3 starts the process of outputting the frame video data of a certain frame repeatedly for three frames, and changes to Low level while the frame video data is outputted repeatedly for three frames. The frame rate conversion control signal Sig1 is kept at Low level while the frame rate converting module 3 outputs the frame video data of a certain frame repeatedly for two frames.

As stated above, the frame rate conversion control signal Sig1 has a function of notifying the depth data generating module 4 that the process of outputting frame video data repeatedly for three frames is about to be started.

The frame rate conversion control signal Sig1 should not be necessarily generated by the frame rate converting module 3, and may be supplied from the outside of a video processing device 1 or may be supplied from a control signal generator separately arranged in the video processing device 1. Also when being supplied from the outside, the frame rate conversion control signal Sig1 changes to High level immediately before the frame rate converting module 3 starts the process of outputting the frame video data of a certain frame repeatedly for three frames, and changes to Low level while the frame video data is outputted repeatedly for three frames.

If the frame rate conversion control signal Sig1 is at High level, the depth data generating module 4 outputs the same depth data repeatedly for three frames at the next frame switching timing. On the other hand, if the frame rate conversion control signal Sig1 is at Low level, the same depth data is outputted repeatedly for two frames at the next frame switching timing.

As stated above, the depth data generating module 4 determines whether it should output the depth data repeatedly for two frames or repeatedly for three frames, depending on the logic of the frame rate conversion control signal Sig1 generated by the frame rate converting module 3, and thus the depth data is repeatedly outputted at a frequency corresponding to the number of times the frame video is outputted by the frame rate converting module 3. In this way, the frame rate converting module 3 and the depth data generating module 4 can operate completely in synchronization with each other.

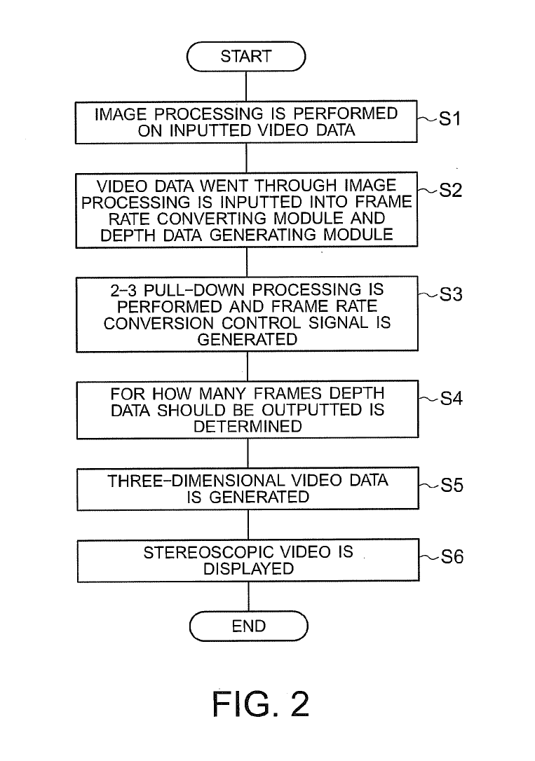

FIG. 2 is a flow chart showing an example of the processing operation performed by the video processing device 1 of FIG. 1. This flow chart shows an example in which two-dimensional video data or three-dimensional video data having a frame rate of 24 fps (hereinafter referred to simply as video data) is inputted into the video processing module 2 from the video source 10.

When the video data is inputted into the video processing module 2, the video processing module 2 performs image processing thereon (Step S1). The image processing means performing a decoding process and then a denoising process, for example. The video data after the image processing by the video processing module 2 is inputted into both of the frame rate converting module 3 and the depth data generating module 4 (Step S2).

The frame rate converting module 3 generates 60-fps video data by performing the above-mentioned 2-3 pull-down processing, and further generates the frame rate conversion control signal Sig1 and supplies it to the depth data generating module 4 (Step S3). The process of Step S3 will be explained in detail later.

The depth data generating module 4 determines whether it should output the depth data repeatedly for two frames or repeatedly for three frames, depending on the logic of the frame rate conversion control signal Sig1 transmitted from the frame rate converting module 3 (Step S4).

Next, the three-dimensional data generating module 5 generates three-dimensional video data, based on the frame video having a frame rate converted by the frame rate converting module 3 and the depth data synchronously generated by the depth data generating module 4 (Step S5).

Here, the three-dimensional video data includes right-eye parallax data and left-eye parallax data. Further, multi-parallax data of three or more parallaxes may be generated as the three-dimensional video data. When generating multi-parallax data, depth data corresponding to each parallax should be generated by the depth data generating module 4. More concretely, the depth data generating module 4 generates multi-parallax data by performing the processes of restoring depth information by performing motion detection using two frame videos, restoring depth information by automatically identifying the composition of the frame video, and restoring depth information of a face part by detecting a human face in the frame video.

The three-dimensional video data generated by the three-dimensional data generating module 5 is transmitted to the flat display device 6 and a stereoscopic video is displayed (Step S6). More concretely, pixels corresponding to the parallax data are displayed on the display panel 7 of the flat display device 6. In this way, stereoscopic video can be observed by the human eyes in a viewing area. Here, the viewing area shows a range in which a three-dimensional (stereoscopic) video displayed on the display panel 7 can be watched by a human. A concrete location of the viewing area is determined by the combination of display parameters of the flat display device 6. Used as the display parameters are relative position of each display element of the display panel 7 to the light ray controlling element 8 corresponding thereto, distance between the display element and the light ray controlling element 8 corresponding thereto, angle of the display panel 7, and pitch of each pixel of the display panel 7, for example.

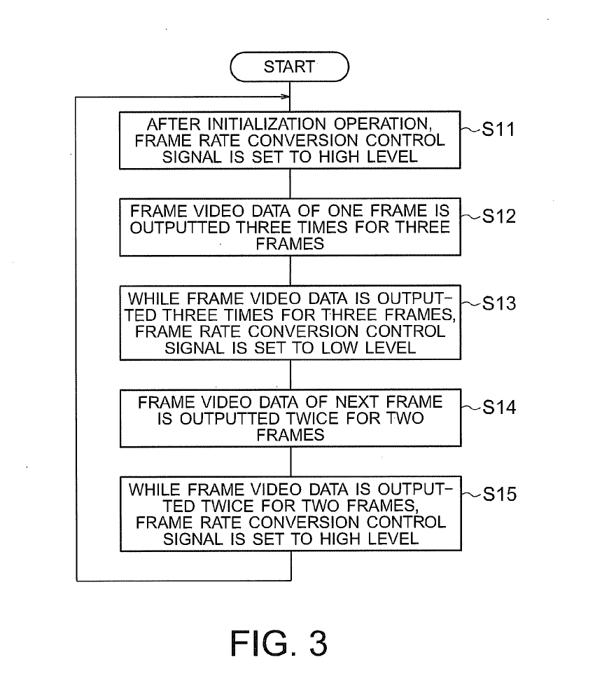

FIG. 3 is a flow chart showing an example of a detailed process step of Step S3 in FIG. 2. After an initialization operation, when the video data after the image processing by the video processing module 2 is inputted into the frame rate converting module 3, the frame rate conversion control signal Sig1 is set to High level first (Step S11). Subsequently, frame video data of one frame included in the video data is outputted repeatedly for three frames (Step S12). While the frame video data is outputted repeatedly for three frames, the frame rate conversion control signal Sig1 is set to Low level (Step S13).

As stated above, immediately after the video processing device 1 of FIG. 1 performs the initialization operation, the frame rate converting module 3 sets the frame rate conversion control signal Sig1 to High level, and outputs frame video data of one frame repeatedly for two frames. This is merely an example, and it is also possible that, immediately after the initialization operation, the frame rate conversion control signal Sig1 is set to Low level, and frame video data of one frame is outputted repeatedly for two frames.

When the repetitive output for three frames in the above Step S12 is completed, frame video data of the next frame is outputted repeatedly for two frames (Step S14). While the frame video data is outputted repeatedly for two frames, the frame rate conversion control signal Sig1 is set to High level (Step S15).

After that, the flow returns to Step S12, and the processes of Steps S12 to S15 are repeated.

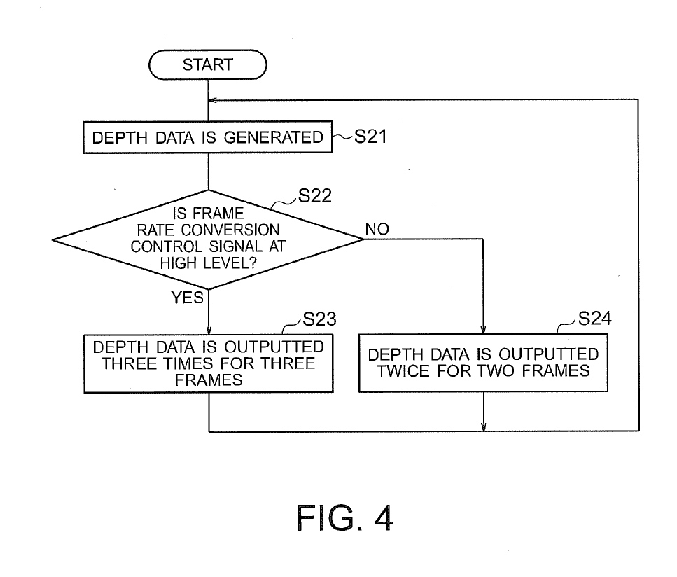

FIG. 4 is a flow chart showing an example of a detailed processing procedure of Step S4 in FIG. 2. When the video data after the image processing by the video processing module 2 is inputted into the depth data generating module 4, the module 4 generates depth data corresponding to this video data (Step S21).

A concrete method for generating the depth data is not limited. In the case of two-parallax data, the depth data is not necessarily essential, but the present embodiment is premised on generating the depth data. The depth data may be obtained by utilizing the depth data previously included in the video source 10, or by performing motion detection, composition identification, and face detection as stated above.

Next, whether the frame rate conversion control signal Sig1 transmitted from the frame rate converting module 3 is at High level is judged (Step S22). If High level, the depth data generated in Step S21 is outputted repeatedly for three frames (Step S23). On the other hand, if Low level, the depth data generated in Step S21 is outputted repeatedly for two frames (Step S24).

When the process of Step S22 or Step S23 is completed, the flow returns to Step S21, and the processes of Steps S21 to S24 are repeated.

As stated above, the depth data generating module 4 determines whether it should output the depth data repeatedly for three frames or repeatedly for two frames, depending on the logic of the frame rate conversion control signal Sig1 transmitted from the frame rate converting module 3. Each of the frame rate converting module 3 and the depth data generating module performs its process with a frame cycle synchronizing with a vertical synchronization signal, and as a result, the frame video data generated by the frame rate converting module 3 and the depth data generated by the depth data generating module are completely synchronized with each other. Hereinafter, this operation will be explained using a timing diagram.

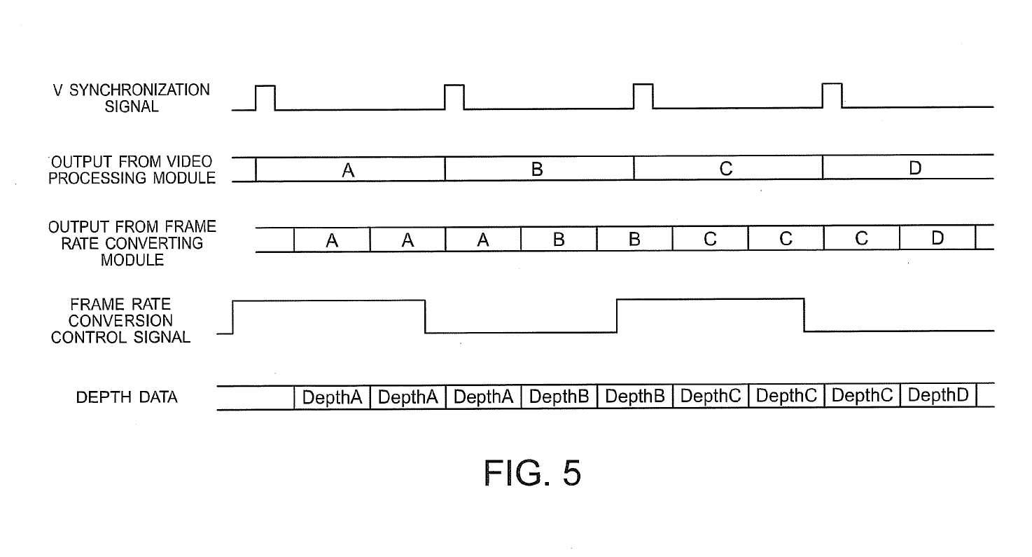

FIG. 5 is an operation timing diagram of the components of the video processing device 1 of FIG. 1. FIG. 5 is a timing diagram of the vertical synchronization signal (V synchronization signal), the output signal from the video processing module 2, the output signal from the frame rate converting module 3, the frame rate conversion control signal Sig1, and the depth data.

The vertical synchronization signal is a pulse signal outputted once for each frame. The output signal from the video processing module 2 is outputted nearly in synchronization with the vertical synchronization signal. The output signal from the frame rate converting module 3 is outputted at a timing slightly delayed from the output signal of the video processing module 2.

The frame rate conversion control signal Sig1 in an initialized state is surely set to High level, and then set to High level once every two frames. The frame rate conversion control signal Sig1 changes from Low level to High level before the pulse of the vertical synchronization signal is outputted. As shown in FIG. 5, when the frame rate conversion control signal Sig1 becomes High level, depth data corresponding to the next frame video data is outputted repeatedly for three frames.

As stated above, the frame rate conversion control signal Sig1 is set to High level to preliminarily notify the depth data generating module 4 that the frame rate converting module 3 outputs the frame video data repeatedly for three frames. Thus, when the frame video data is outputted repeatedly for three frames, the depth data corresponding thereto is surely outputted repeatedly for three frames. In this way, the frame video data and the depth data are completely synchronized with each other.

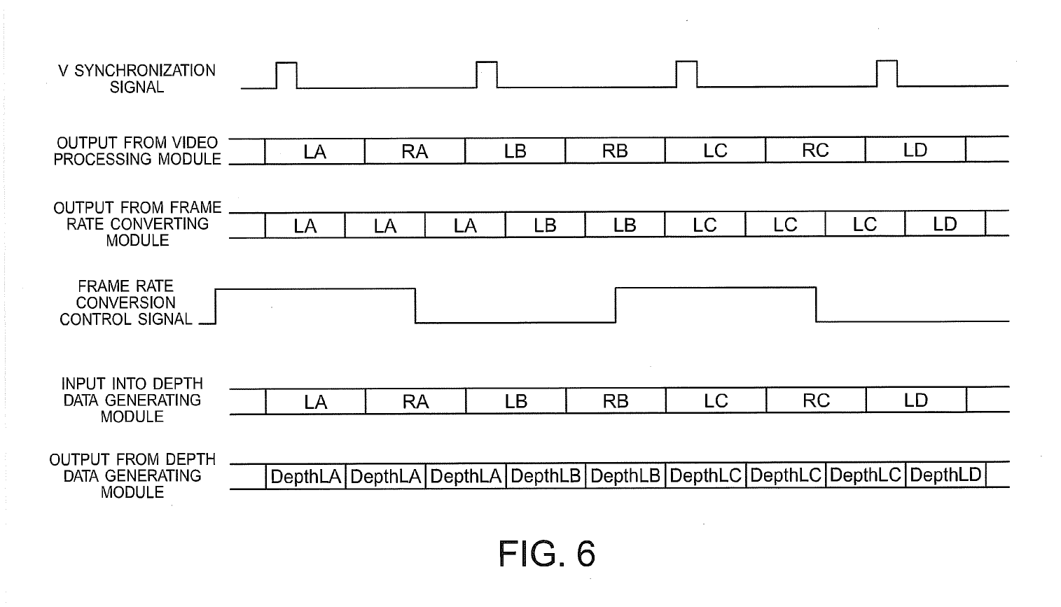

FIG. 5 shows the operation timing when two-dimensional video data is inputted into the video processing module 2 from the video source 10, but the video data provided from the video source 10 may be three-dimensional video data, as stated above. Frame packing with 1920×1080p at 23.976 Hz Frame Packing will be employed as a concrete example. The operation timing diagram in this case is as shown in FIG. 6.

FIG. 6 is a timing diagram of the vertical synchronization signal (V synchronization signal), the output signal from the video processing module 2, the output signal from the frame rate converting module 3, the frame rate conversion control signal Sig1, the input signal into the depth data generating module 4, and the output signal from the depth data generating module 4.

The output signal from the video processing module 2 alternately includes left-eye parallax data and right-eye parallax data for each frame. The frame rate converting module 3 performs frame rate conversion using only the left-eye parallax data, and alternately outputs the frame video data formed of the left-eye parallax data repeatedly for three frames and the left-eye parallax data repeatedly for two frames.

Similarly to the frame rate conversion control signal Sig1 of FIG. 5, the frame rate conversion control signal Sig1 in an initialized state is once set to High level, and then alternately switches between High level and Low level in synchronization with the output signal from the frame rate converting module 3.

On the other hand, the depth data generating module 4 is inputted with both of the left-eye parallax data and the right-eye parallax data, and utilizes these data to generate depth data. Then, the depth data generating module 4 alternately outputs the depth data repeatedly for three frames and the depth data repeatedly for two frames, depending on the logic of the frame rate conversion control signal Sig1.

As stated above, in the present embodiment, when performing 2-3 pull-down processing to convert the frame rate from 24 fps to 60 fps, the frame rate conversion control signal Sig1 is set to High level to notify the depth data generating module 4 that the frame rate converting module 3 will start the process of outputting the frame video data repeatedly for three frames. Thus, the depth data generating module 4 can correctly grasp the timing when the depth data is outputted repeatedly for three frames. Therefore, the frame video data and the depth data can be correctly related to each other, and thus there is no likelihood that incorrect depth data is related to the frame video data. Accordingly, the frame video data and the depth data can be correctly synchronized with each other, and display quality of the three-dimensional video can be improved.

It should be noted that the frame frequency converted through the 2-3 pull-down processing is not just 60 fps, and has a value approximate to 60 fps. Accordingly, at a frequency of once every hundreds of frames, the process of outputting repeatedly for two frames or the process of outputting repeatedly for three frames should be sequentially repeated twice. That is, even when converting the frame frequency from 24 fps to 60 fps, the 2-3 pull-down processing is not performed all the time. For example, when each of the frame rate converting module 3 and the depth data generating module 4 performs the process of repeating output repeatedly for two frames, the frame rate conversion control signal Sig1 is not changed to High level and fixed at Low level during the process. To the contrary, when each of the frame rate converting module 3 and the depth data generating module 4 performs the process of repeating output repeatedly for three frames, the frame rate conversion control signal Sig1 should be fixed at High level during the process.

Further, although the 2-3 pull-down processing is explained in the above example, the frame rate conversion is not limited to a conversion from 24 fps to 60 fps. When converting the frame rate into an integral multiple or an integral fraction as in the conversion from 30 fps to 60 fps, the number of times the frame video data should be outputted is always constant, and thus there is no need to arrange the above frame rate conversion control signal Sig1. When the number of times the frame video data should be outputted changes, the frame rate converting module 3 can notify the depth data generating module 4 about the number of times the next frame video data will be outputted by switching the logic of the frame rate conversion control signal Sig1, as stated above, by which both of the modules can operate completely in synchronization with each other.

As stated above, even when the 2-3 pull-down processing is not performed, the present invention can be widely employed if the number of times the frame video data is outputted changes.

The video processing device 1 of FIG. 1 is shown as an example of a video display device which supplies the three-dimensional video data generated by the three-dimensional data generating module 5 to the flat display device 6, but the video processing device 1 according to the present embodiment may be formed as a recording device which records the three-dimensional video data generated by the three-dimensional data generating module 5 in a DVD, BD, HDD, etc. Alternatively, the video processing device 1 according to the present embodiment may be formed as an optical disk reproducing device which generates and reproduces three-dimensional video data using the video source 10 of an optical disk such as a DVD, BD, etc. Further alternatively, the video processing device 1 may be formed as a digital AV reproducing device or a PC which generates and reproduces three-dimensional video data using digital video content downloaded through the Internet. Still further, the present embodiment may be applied to a smartphone, a cellular phone, and a mobile game machine.

At least a part of the video processing device 1 explained in the above embodiments may be implemented by hardware or software. In the case of software, a program realizing at least a partial function of the video processing device 1 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the video processing device 1 can be distributed through a communication line (including radio communication) such as the Internet. Furthermore, this program may be encrypted, modulated, and compressed to be distributed through a wired line or a radio link such as the Internet or through a recording medium storing it therein.
While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A video processing device comprising:
an image processor configured to perform image processing on two-dimensional or three-dimensional input video data;
a frame rate converter configured to perform frame rate conversion to
output video data of a first one frame of successive two frames of the video data after the image processing by the image processor repeatedly for a first frame number of times and
output video data of another frame of the successive two frames of the video data repeatedly for a second frame number of times;
a depth data generator configured to generate depth data corresponding to the video data corresponding to the video data of each frame, depending on a logical value of a control signa for changing from a first logical value to a second logical value after beginning to output the video data for first frame number of times until ending to output the video data for the first frame number of times and changing from the second logical value to the first logical value after beginning to output the video data for the second frame number of times until ending to output the video data for the second frame number of times; and
a three-dimensional data generator configured to generate three-dimensional video data based on
the video data of each frame after the frame rate conversion by the frame rate converter, and
the depth data corresponding to the video data of each frame.

2. The video processing device of claim 1, wherein the frame rate converter performs the frame rate conversion and generates the control signal.

3. The video processing device of claim 1, wherein the depth data generator
outputs newly generated depth data repeatedly for the first frame number of times when the control signal is in the second logical value, and
outputs newly generated depth data repeatedly for the second frame number of times when the control signal is in the first logical value.

4. The video processing device of claim 1, wherein
the input video data includes right-eye video data and left-eye video data,
the frame rate converter performs the frame rate conversion using any one of the right-eye video data and the left-eye video data, and
the depth data generator generates the depth data using the right-eye video data and the left-eye video data.

5. The video processing device of claim 1, wherein the frame rate converter
changes the logical value of the control signal from the first logical value to the second logical value, and then
changes the logical value of the control signal from the second logical value to the first logical value while outputting the video data of the one frame repeatedly for the first frame number of times.

6. The video processing device of claim 1, wherein
the first frame number is 3 and the second frame number is 2 when the input video data has a frame rate of 24 frames/second and
the three-dimensional video data generated by the three-dimensional data generator has a frame rate of 60 frames/second.

7. The video processing device of claim 1, wherein in the case of normal frames after the frame rate conversion by the frame rate converter, the first frame number is larger than the second frame number, and the first frame number becomes equal to the second frame number once every predetermined number of frames.

8. The video processing device of claim 1, further comprising a receiver module configured to generate the input video data by receiving a broadcast wave and performing a demodulation process thereon.

9. The video processing device of claim 1, wherein the three-dimensional data generator generates and reproduces three-dimensional video data corresponding to the input video data read from an optical disc.

10. The video processing device of claim 1, further comprising a recorder configured to record the three-dimensional video data generated by the three-dimensional data generator.

11. A video processing device, comprising:
an image processor configured to perform image processing on two-dimensional or three-dimensional input video data;
a three-dimensional information generation preparing unit configured to generate depth data corresponding to the video data for each frame, depending on a logical value of a control signal for changing from a first logical value to a second logical value after be beginning after beginning to output the video data for first frame number of times until ending to output the video data for the first frame number of times and changing from the second logical value to the first logical value after beginning to output the video data for the second frame number of times until ending to output the video data for the second frame number of times; and
a three-dimensional data generator configured to generate three-dimensional video data based on
the video data after the frame rate conversion, and
the depth data corresponding to the video data of each frame.

12. A video processing method, comprising:
performing image processing on two-dimensional or three-dimensional input video data;
performing frame rate conversion to
output video data of one frame of successive two frames of the video data after the image processing repeatedly for a first frame number of times and
output video data of another frame of the successive two frames of the video data repeatedly for a second frame number of times;
generating depth data corresponding to the video data of each frame, depending on a logical value of a control signal for changing from a first logical value to a second logical value after beginning to output the video data for first frame number of times until ending to output the video data for the first frame number of times and changing from the second logical value to the first logical value after beginning to output the video data for the second frame number of times until ending to output the video data for the second frame number of times; and
generating three-dimensional video data based on
the video data of each frame after the frame rate conversion, and
the depth data corresponding to the video data of each frame.

13. The method of claim 12, wherein the frame rate conversion performs the frame rate conversion and generates the control signal.

14. The method of claim 12, wherein the generating depth data
outputs newly generated depth data repeatedly for the first frame number of times when the control signal is in the second logical value, and
outputs newly generated depth data repeatedly for the second frame number of times when the control signal is in the first logical value.

15. The method of claim 12, wherein
the input video data includes right-eye video data and left-eye video data,
the frame rate conversion performs the frame rate conversion using any one of the right-eye video data and the left-eye video data, and
the generating depth data generates the depth data using the right-eye video data and the left-eye video data.

16. The method of claim 12, wherein the frame rate conversion
changes logical value of the control signal from the first logical value to the second logical value, and then
changes logical value of the control signal from the second logical value to the first logical value while outputting the video data of the one frame repeatedly for the first frame number of times.

17. The method of claim 12, wherein
the first frame number is 3 and the second frame number is 2 when the input video data has a frame rate of 24 frames/second and
the three-dimensional video data generated by the three-dimensional data generator has a frame rate of 60 frames/second.

18. The method of claim 12, wherein in the case of normal frames after the frame rate conversion, the first frame number is larger than the second frame number, and the first frame number becomes equal to the second frame number once every predetermined number of frames.

19. The method of claim 12, further comprising generating the input video data by receiving a broadcast wave and performing a demodulation process thereon.

20. The method of claim 12, wherein the generating three-dimensional data generates and reproduces three-dimensional video data corresponding to the input video data read from an optical disc.
